(19) United States
(12) Patent Application Publication
(10) Pub. No.: US 2008/0200190 A1
(43) Pub. Date: Aug. 21, 2008

(54) APPARATUS AND METHOD FOR TRANSFORMING A WIRELESS ACCESS PROTOCOL (WAP) PUSH MESSAGE TO A FORMATTED PACKET FOR A MULTIMEDIA MESSAGING SERVICE

(75) Inventors: Rob MALCOLM, London (GB); Randy LEUNG, The Woodlands, TX (US); Anthony D. MAYES, West Sussex (GB); Ian CASS, Kent (GB)

Correspondence Address: COOLEY GODWARD KRONISH LLP;ATTN: Patent Group, Suite 1100, 777 - 6th Street, NW, Washington, DC, 20001, US

(73) Assignee: MBLOX INC., Sunnyvale, CA (US)

(21) Appl. No.: 11/676,256

(22) Filed: Feb. 16, 2007

(51) Int. Cl. H04Q 7/20

(52) U.S. Cl. 455/466

(57) ABSTRACT

A method includes intercepting a Wireless Access Protocol (WAP) push message and accessing a Uniform Resource Locator (URL) associated with the WAP push message to access a resource. Content from the resource is received via a WAP session. The content is packaged as a Multimedia Messaging Service (MMS) packet. The MMS packet is routed to a wireless carrier.

### BRIEF DESCRIPTION OF THE INVENTION

The invention relates generally to the delivery of content to wireless devices. More particularly, the invention relates to transforming a Wireless Access Protocol (WAP) push message to a formatted packet for a Multimedia Messaging Service.

### BACKGROUND OF THE INVENTION

FIG. 1 illustrates a prior art Wireless Access Protocol (WAP) system for delivering content via the Short Message Peer-to-peer Protocol (SMPP). WAP is an open international standard for applications that use wireless communication. Its principal application is to enable access to the Internet from a mobile device (e.g., mobile phone, personal digital assistant, and the like). A WAP browser is designed to provide all of the basic services of a computer based web browser, but is simplified to operate within the restrictions of a mobile device. WAP is the protocol used for the majority of the world's mobile internet sites, known as WAP sites. WAP sites are websites written in, or dynamically converted to, Wireless Markup Language (WML) to facilitate access via a WAP browser.

SMPP is a telecommunication industry protocol for exchanging Short Message Service (SMS) messages between SMS peer entities. SMPP allows an entity to broadcast messages,

lobe term WAP Push refers to an SMS message with a link to a WAP site Uniform Resource Locator (URL). A mobile handset accesses he URL to retrieve WML content.

The system 100 of FIG. 1 includes a message service 102. The message service 102 operates to convert a message into a wireless transport message. A message service is sometimes referred to as a Value-Added Service Provider (VASP). An exemplary message service 102 is described in U.S. Pat. No. 6,347,340, the contents of which are incorporated herein by reference.

A content provider 104 delivers a message to a message service 102. For example, the message may be communicated via SMPP. The SMPP link 106 subsequently routes the message to a wireless carrier 110. The wireless carrier 110 includes an SMPP gateway 114 and a Short Message Service Center 116, which facilitates communication with a handset 120. Alternately, the message may be communicated via an eXtensible Markup Language (XML) message communicated via an Internet Protocol (IP) connection. XML is used to format an SMS message, which is then routed by the message service 102 using the SMPP link 106. Similarly, a JAVA® message may be used initiate the WAP push session.

FIG. 2 illustrates a WAP push message originating at a content provider 104. The WAP push message is passed to the message service 102, as shown with arrow 200. The message service 102 then passes the message to the wireless carrier 110, as shown with arrow 202. The wireless carrier 110 then delivers the message to the handset 120, as shown with arrow 204. When the handset 120 receives the signal, it wakes up and an initiates a WAP session. Thereafter, the handset 120 accesses a Uniform Resource Locator (URL) associated with the WAP push message. The URL is conveyed to the wireless carrier 110, as shown with arrow 206. The wireless carrier 110 then conveys the URL to the content provider 104, as shown with arrow 208.

Arrow 206 of FIG. 2 corresponds to arrow 122 of FIG. 1, while arrow 208 of FIG. 2 corresponds to arrow 123 of FIG. 1. Referring to FIG. 1, the content server 124 is associated with the internet 126. The content server 124 is associated with the content provider 104. The content server 124 delivers content to the wireless carrier 110 over link 123 via a WAP session. The wireless carrier 110 then delivers the content to the handset via link 122 (link 212 in FIG. 2). Link 122 may utilize any number of communication protocols (e.g., General Packet Radio Service (GPRS) or CDMA Packet Data (1×RTT)).

The Multimedia Messaging Service (MMS) is a telephony standard that allows sending messages that include multimedia objects, such as image objects, audio objects video objects and rich text objects. MM7 is a interface between a Multimedia Messaging Service Center (MMSC) and a message service or WASP. MM7 is based on the Simple Object Access Protocol (SOAP), using the HyperText Transport Protocol (HTTP). MM7 messages are encoded using XML. One significant advantage of MM7 is its transport capacity, which is much larger than the transport capacity of SMS.

Migration to MMS is inhibited by the requirement to upgrade systems to support MM7 packaging protocols. As a result, content providers have been slow to exploit the speed advantages of MMS.

Therefore, it would be desirable to provide a mechanism to leverage existing SMS infrastructure, while providing the benefits of MMS.

### SUMMARY OF THE INVENTION

The invention includes a method of intercepting a Wireless Access Protocol (WAP) push message and accessing a Uniform Resource Locator (URL) associated with the WAP push message to access a resource. Content from the resource is received via a WAP session. The content is packaged as a Multimedia Messaging Service (MMS) packet. The MMS packet is routed to a wireless carrier.

The invention also includes a message service with a Wireless Access Protocol (WAP) session module to intercept a WAP push message, access a Uniform Resource Locator (URL) associated with the WAP push message, and receive content from the resource via a WAP session. A Multimedia Messaging Service (MMS) conversion module packages the content as a Multimedia Messaging Service (MMS) packet to route the MMS packet to a wireless carrier.

### BRIEF DESCRIPTION OF THE FIGURES

The invention is more fully appreciated in connection with the following detailed description taken in conjunction with the accompanying drawings, in which:

FIG. 1 illustrates a prior art Wireless Access Protocol (WAP) system for delivering content via the short message peer-to-peer protocol.

FIG. 2 illustrates processing operations associated with the system of FIG. 1.

FIG. 3 illustrates a system for delivering content via a Multimedia Messaging Service (MMS) in accordance with an embodiment of the invention.

FIG. 4 illustrates processing operations associated with the system of FIG. 3.

FIG. 5 illustrates processing operations associated with a delivery receipt embodiment of the system of FIG. 3.

Like reference numerals refer to corresponding parts throughout the several views of the drawings.

### DETAILED DESCRIPTION OF THE INVENTION

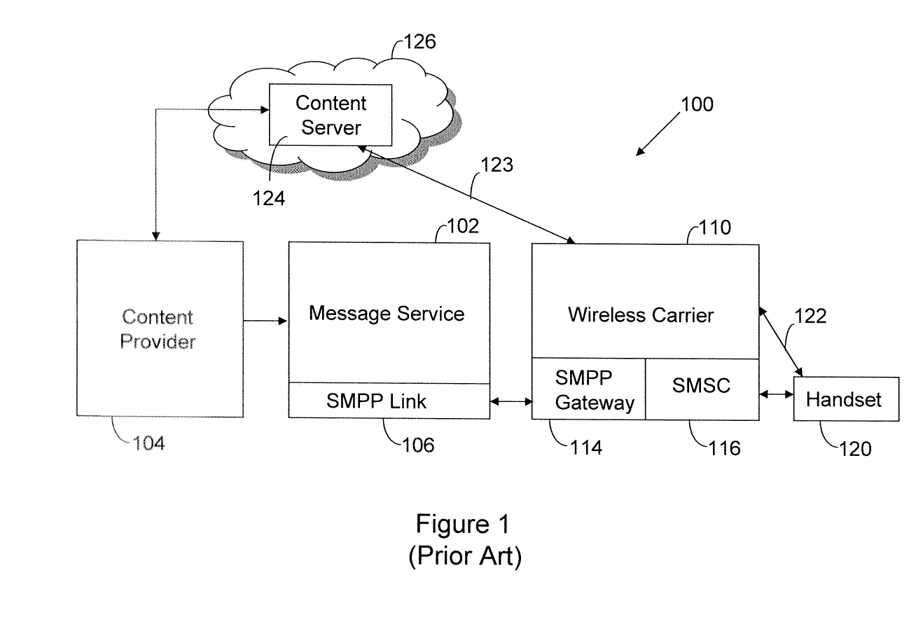

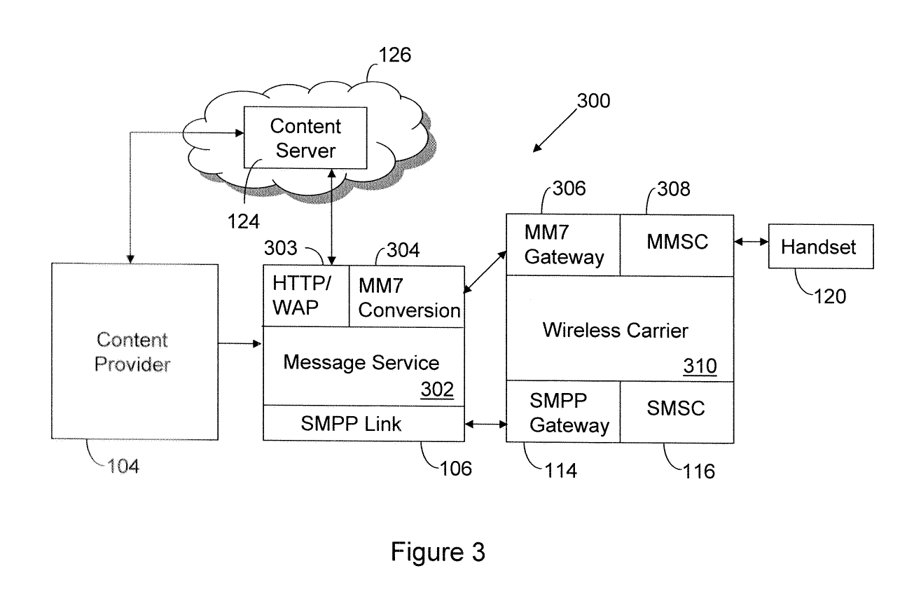

FIG. 3 illustrates a system 300 configured in accordance with an embodiment of the invention. The system 300 includes a message service 302, which includes an SMPP link 106, as was the case of the prior art system of FIG. 1. However, the message service 302 also includes a HTTP/WAP access module 303, which operates as a handset proxy to fetch WAP push content. The message service 302 also includes an MM7 conversion module 304 to convert retrieved WAP content to an MM7 message format, which is then passed to a wireless carrier 310. The HTTP/WAP access module 303 and the MM7 conversion module 304 may be implemented as executable instructions operative for execution on a central processing unit associated with the message service 302.

The wireless carrier 310 includes an MM7 gateway 306 to process the MM7 message. The MM7 gateway 306 communicates with a Multimedia Service Center (MMSC) 308 to deliver the MM7 message to the handset 120. The wireless carrier 310 also includes an SMPP gateway 114 and an SMSC 116, consistent with the wireless carrier configuration of FIG. 1.

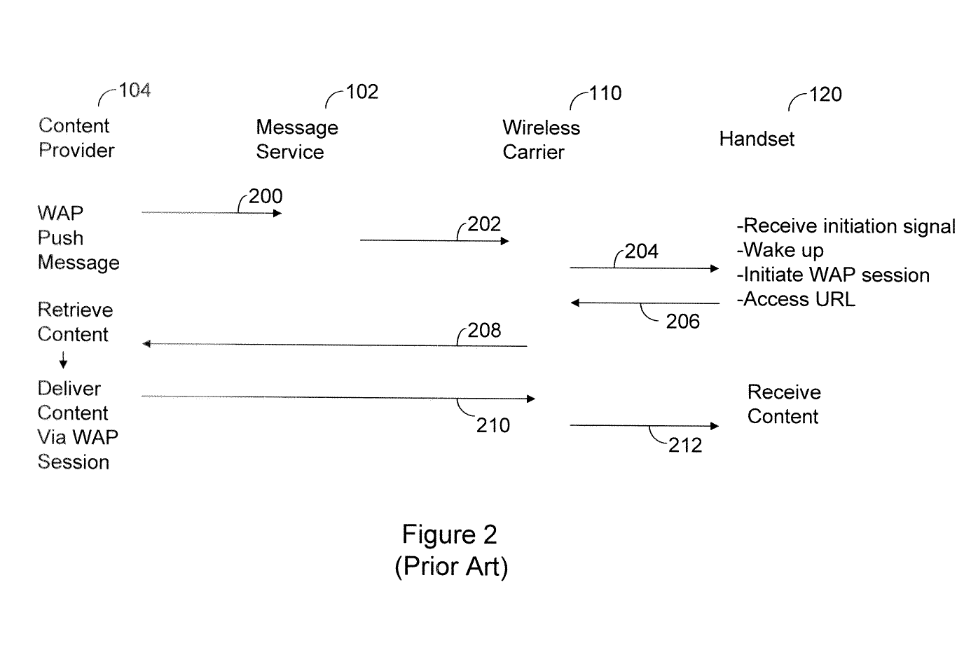

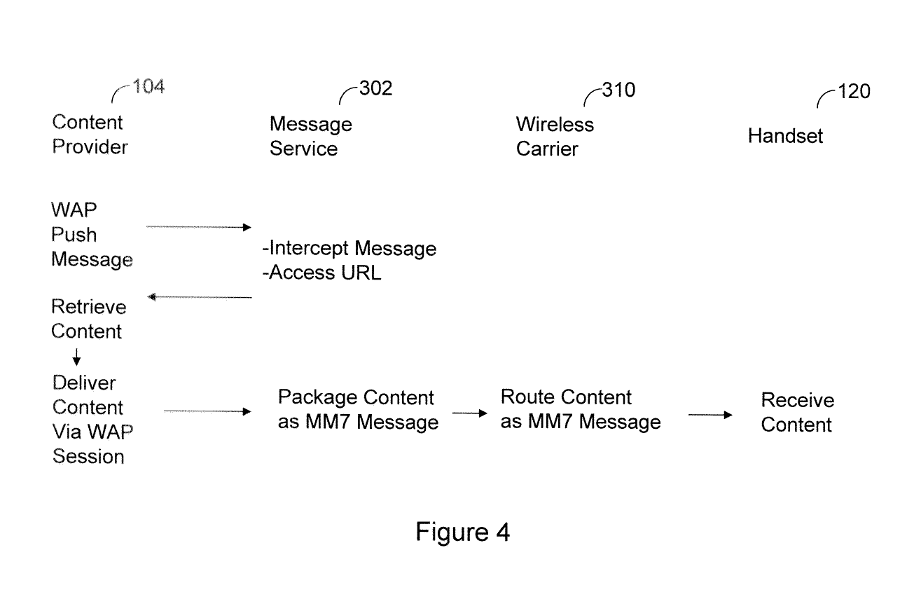

The operation of the system 300 of FIG. 3 is more fully appreciated with reference to FIG. 4. FIG. 4 illustrates that a WAP push message originates at a content provider, as was the case in FIG. 2. In other words, a content provider can generate a WAP push message using SMS, as was the case in FIG. 2. However, in the processing of FIG. 4, the message service 302 (e.g., the HTTP/WAP module 303) intercepts the message and accesses the specified URL. Thus, the message service 302 operates as a handset proxy to retrieve content without using the handset to retrieve content, as was the case in the processing of FIG. 2.

The content provider retrieves the specified content and delivers it to the message service 302 via a WAP session. The content is typically in the form of a flat file that is readily converted to another format. The message service then packages the content as an MMS packet. For example, the MM7 protocol (e g. Version 6.3) may be used by the MM7 conversion module 304 to generate an MM7 message. As specified in the MM7 protocol, the message conforms to the Simple Object Access Protocol (SOAP) and uses HTTP as the transport protocol. The encoding of the message is done with XML. The MM7 message is then routed to the wireless carrier 310, which delivers it to the handset 120.

Thus, FIG. 4 illustrates an SMS push message being routed to a message service 302, which intercepts the message, retrieves specified content, formats the specified content as an MM7 message and then delivers the content to the handset 120 via the wireless carrier 310. While the wireless carrier is configured with the MM7 gateway 306 and the MMSC 308 to support this functionality, the content provider 104 and its associated content server 124 need not be modified to support this new functionality. Therefore, a content provider can extend its platform to MM7 messages without any infrastructure upgrade.

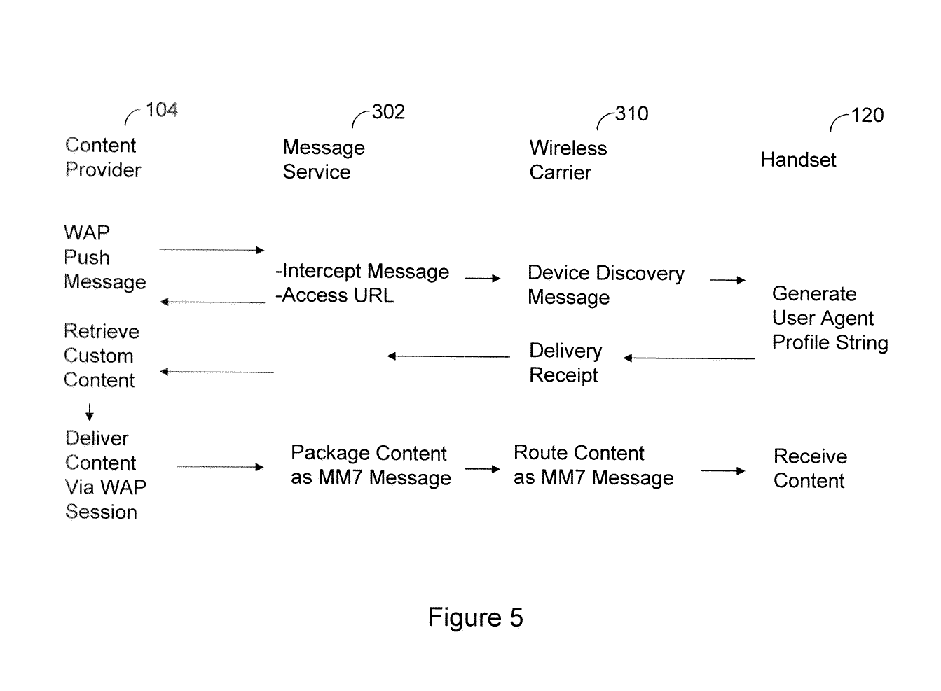

Observe in FIG. 4 that the message is intercepted and the handset 120 is not part of the processing sequence until it actually receives the content. FIG. 5 illustrates an alternate embodiment of the invention in which after intercepting the message, a device discovery message is sent to the wireless carrier 310, which relays it to the handset 120. In response, the handset 120 supplies a user agent profile string, which specifies such things as the device type, the browser type, etc. This information is loaded into a delivery receipt, which is sent from the handset 120 to the wireless carrier 310, which passes it to the message service 302, which passes it to the content provider 104. More particularly, the MMSC 308 processes the profile string at a delivery acknowledgment module, which sends a shortened version of the profile string in a delivery report (delivery receipt) to the message service 302, which passes the shortened version of the profile string to the content provider 104.

At this point, the content provider 104 has retrieved the specified URL and can now format the content associated with the URL in accordance with the user agent profile string. In other words, the content can be customized or optimized for the specified user agent. The custom content is then delivered via a WAP session to the message service 302. The remaining processing associated with FIG. 5 is the same as that discussed in connection with FIG. 4.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices: magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method, comprising:
intercepting a Wireless Access Protocol (WAP) push message;
accessing a Uniform Resource Locator (URL) associated with the WAP push message to access a resource;
receiving content from the resource via a WAP session;
packaging the content as a Multimedia Messaging Service (MMS) packet; and
routing the MMS packet to a wireless carrier.

2. The method of claim 1 wherein intercepting includes intercepting the WAP push message at a server operating as a proxy for a user device.

3. The method of claim 2 wherein accessing includes accessing a content server from the server operating as a proxy for the user device

4. The method of claim 3 wherein accessing includes accessing a WAP content server.

5. The method of claim 1 wherein receiving content includes receiving multimedia objects selected from image content, audio content, video content and rich text content.

6. The method of claim 1 wherein packaging includes packaging the content as an MM7 protocol packet.

7. The method of claim 1 further comprising generating a device discovery message.

8. The method of claim further comprising receiving a delivery receipt with a user agent profile strings

9. The method of claim 8 wherein receiving includes receiving custom content in accordance with the user agent profile string.

10. A message service, comprising:
a Wireless Access Protocol (WAP) session module to
intercept a WAP push message,
access a Uniform Resource Locator (URL) associated with the WAP push message,
receive content from the resource via a WAP session;
an Multimedia Messaging Service (MMS) conversion module to package the content as a Multimedia Messaging Service (MMS) packet to route the MMS packet to a wireless carrier.

11. The message service of claim 10 wherein the WAP session module is configured to operate as a proxy for a user device.

12. The message service of claim 10 wherein the WAP session module accesses a WAP content server.

13. The message service of claim 10 wherein the WAP session module processes multimedia objects selected from image content, audio content, video content and rich text content.

14. The message service of claim 10 wherein the MMS conversion module packages the content as an MM7 protocol packet.

15. The message service of claim 10 wherein the WAP session module generates a device discovery message.

16. The message service module of claim 15 wherein the WAP session module receives a delivery receipt with a use agent profile string

17. The message service module of claim 16 wherein the WAP session module receives custom content in accordance with the user agent profile string.
